(19) United States
(12) Patent Application Publication
(10) Pub. No.: US 2006/0131859 A1
(43) Pub. Date: Jun. 22, 2006

(54) Airbag and aribag system

(75) Inventor: Masayoshi Kumagai, Ika-gun (JP)

Correspondence Address: FOLEY AND LARDNER LLP;SUITE 500, 3000 K STREET NW, WASHINGTON, DC, 20007, US

(73) Assignee: TAKATA CORPORATION

(21) Appl. No.: 11/280,406

(22) Filed: Nov. 17, 2005

(30) Foreign Application Priority Data
Dec. 16, 2004 (JP) 2004-364751

(51) Int. Cl. B60R 21/233; B60R 21/239

(52) U.S. Cl. 280/743.1; 280/729

(57) ABSTRACT

A twin airbag with left and right airbag sections joined together. Each of the left and right airbag sections has at least one vent hole in a panel opposite to a corresponding inner facing panel. The vent holes are disposed at positions at which they align with each other when the airbag sections are flattened. Portions of the inner facing panels of the airbag sections may be stitched together through the vent holes.

### BACKGROUND

The present invention relates to an airbag for protecting an occupant in a car crash. In particular, the present invention relates to a twin airbag, which includes left and right airbag sections that inflate on the left and right sides in front of an occupant, respectively. The invention also relates to an airbag system that includes such an airbag.

Japanese Unexamined Patent Application Publication No. 4-292239 (incorporated by reference herein) discloses a twin airbag for protecting an occupant in a car crash. The airbag includes left and right airbag sections that are inflated by a common inflator on the left and right sides in front of an occupant, respectively. In this airbag, the distal ends of the left and right airbag sections are joined together with a tie panel. The airbag is housed in a casing in a folded condition and is covered with a cover. When an inflator (i.e., gas generator) is activated (e.g., in a car crash) to emit a jet of gas, the airbag pushes the cover open and inflates toward the front of an occupant. In this airbag, however, when the left and right airbag sections inflate, the gas from the inflator consistently flows more into a first of the airbag sections than into the second. As a result, the second airbag section inflates later than the first airbag section.

In spite of the aforementioned delayed inflation of one airbag section, the twin airbag disclosed in Japanese Unexamined Patent Application Publication No. 4-292239 does present at least one improvement over conventional twin airbags. Specifically, when this airbag is fully inflated, the left and right airbag sections respectively receive the left and right chest portions of the occupant. As the left and right chest portions have hard and strong ribs, the airbag receives and absorbs the impact of the occupant via the ribs. Moreover, with the airbag in an inflated state, a space is produced between the distal ends of the left and right airbag sections; this space is directed toward the occupant's breastbone, which is between the left and right chest portions. Accordingly, when the occupant's body strikes the airbag, the breastbone (which covers the heart) receives little reaction force from the airbag, thereby advantageously decreasing the load in vicinity of the breastbone.

To inflate left and right airbag sections substantially simultaneously (and symmetrically), a twin airbag has recently been developed that connects the midpoints in the adjacent sides of the left and right airbag sections (i.e., in the direction of the inflation). Accordingly, even if one of the airbag sections begins to inflate later than the other section, the first inflating airbag section may draw the later inflating airbag section to accelerate its inflation. Moreover, the first inflating airbag may start to draw the later inflating airbag in the direction of the inflation at the initial stage when the first airbag inflates to the midpoints. Thus, both the left and right airbag sections inflate smoothly and substantially simultaneously (and symmetrically) from the initial stage of the inflation.

To achieve this uniform inflation, the left and right airbag sections are, as previously mentioned, joined at their midpoints. The left and right airbag section may be joined with a joining member such as a tie belt. Else, the left and right airbag sections may each be provided with a tongue; the airbag sections may then be joined by stitching the tongues. In either case, the joining by the tie belt or by stitching the tongues disadvantageously increases: (a) the time to stitch the left and right airbag sections together and/or (b) the volume of the stitched portion.

Accordingly, the present invention has been made in light of the aforementioned problems. Various objects of the invention include providing a twin airbag and an airbag system in which: (a) left and right airbag sections may be joined together in a manner that does not meaningfully increase the time necessary for the joining and/or the volume of the joined portion; and/or (b) adequately receives the occupant's left and right chest portion while providing a space for the occupant's breastbone.

### SUMMARY

An embodiment of the present invention addresses an airbag that is configured to inflate in a direction in which a distal end of the airbag moves away from a base end of the airbag. The airbag includes, among other possible things: a left airbag section that is configured to inflate toward the left front of an occupant; and a right airbag section that is configured to inflate toward the right front of the occupant. The left and right airbag sections are connected at the base end of the airbag along inner sides of the airbag sections. The left and right airbag sections are configured to be inflated by a common inflator. Each of the left and right airbag sections is provided with at least one vent hole on an outer side, which is opposite to the inner side of the respective airbag section. When the left and right airbag sections are uninflated and are flattened such that the inner sides are adjacent the associated outer sides: (a) the vent holes align with each other, and (b) the inner sides of each of the left and right airbag sections opposite the associated vent holes are stitched together such that midpoints of the inner sides of the left and right airbag sections are joined.

In a further embodiment of this airbag, the joined portions of the inner sides of the left and right airbag sections may each have a patch.

In another further embodiment of this airbag, the joined portions of the inner sides of the left and right airbag sections may be stitched together with a ring-shaped seam. Further, an opening may be provided inside the ring-shaped seam, through which the left and right airbag sections may communicate.

Another embodiment of the present invention addresses an airbag system. The airbag system includes, among other possible things: an inflator; and an airbag that is configured to inflate in a direction in which a distal end of the airbag moves away from a base end of the airbag. The airbag includes, among other possible things: a left airbag section that is configured to inflate toward the left front of an occupant; and a right airbag section that is configured to inflate toward the right front of the occupant. The left and right airbag sections are connected at the base end of the airbag along inner sides of the airbag sections. The left and right airbag sections are configured to be inflated by the inflator. Each of the left and right airbag sections is provided with at least one vent hole on an outer side, which is opposite to the inner side of the respective airbag section. When the left and right airbag sections are uninflated and are flattened such that the inner sides are adjacent the associated outer sides: (a) the vent holes align with each other, and (b) the inner sides of each of the left and right airbag sections opposite the associated vent holes are stitched together such that midpoints of the inner sides of the left and right airbag sections are joined.

In a further embodiment of this airbag system, the joined portions of the inner sides of the left and right airbag sections may each have a patch.

In another further embodiment of this airbag system, the joined portions of the inner sides of the left and right airbag sections may be stitched together with a ring-shaped seam. Further, an opening may be provided inside the ring-shaped seam, through which the left and right airbag sections may communicate.

In the aforementioned airbag and airbag system, the stitching of the airbag sections may be accomplished, through the vent holes, by, e.g., use of a sewing machine, thereby facilitating the stitching. Moreover, the application of a patch to the stitched portions may increase stitching strength. In addition, if the stitch is a ring-shaped seam, the inside of which is opened such that the airbag sections may communicate, the inner pressure of the airbag sections may be equalized.

It is to be understood that both the foregoing general description and the following detailed description are exemplary and explanatory only, and are not restrictive of the invention as claimed.

### BRIEF DESCRIPTION OF THE DRAWINGS

These and other features, aspects, and advantages of the present invention will become apparent from the following description, appended claims, and the accompanying exemplary embodiments shown in the drawings, which are briefly described below.

FIG. 1A is a perspective view an airbag embodiment according to the present invention;

FIG. 1B is a cross-sectional view of the airbag shown in FIG. 1A taken along line B-B;

FIG. 2 is a cross sectional view of the airbag shown in FIGS. 1A and 1B, taken along line II-II of FIG. 11B;

FIG. 3, which is a cross-sectional view of a joint structure of the airbag of FIGS. 1A and 1B, shows how inner facing panels of a left airbag section and a right airbag section are stitched together;

FIG. 4 is a cross-sectional view of a joint structure of an airbag according to another embodiment of the present invention;

FIG. 5 is a cross-sectional view of a joint structure of an airbag according to yet another embodiment of the present invention;

FIG. 6 is an exploded perspective view of the airbag of FIG. 5;

FIG. 7 is a perspective view of the airbag in FIG. 5;

FIG. 8A cross-sectional view of a joint structure of an airbag according to another embodiment of the present invention;

FIG. 8B is a perspective view of an opening of the airbag embodiment shown in FIG. 8A; and

FIG. 9 is a cross-sectional view of a joint structure of an airbag according to another embodiment of the present invention.

### DETAILED DESCRIPTION

Embodiments of the present invention will be described with reference to the drawings. Like numbers are used throughout the drawings to refer to the same or similar parts in each of the embodiments of the invention described herein.

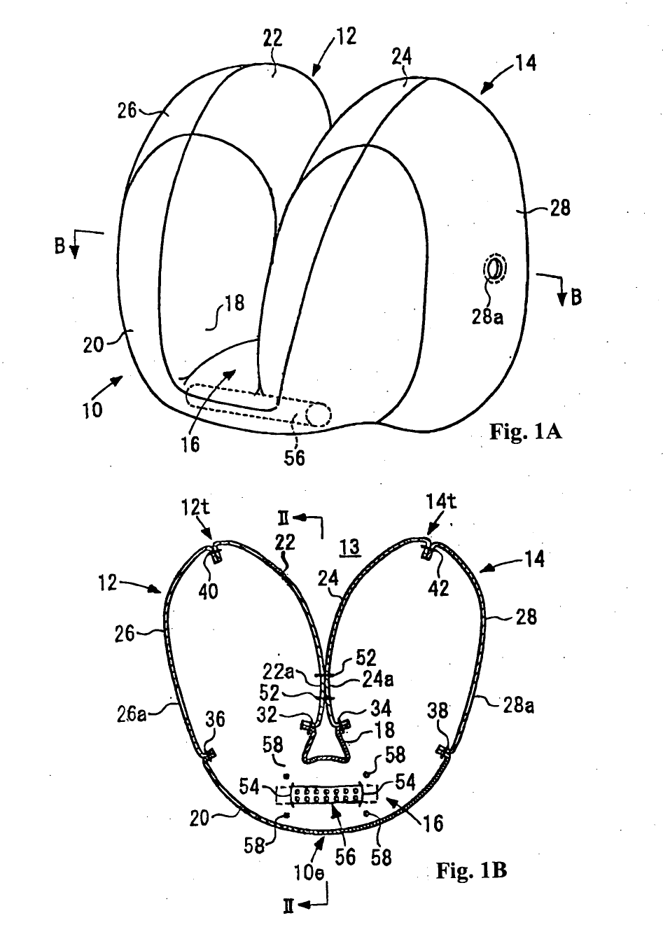

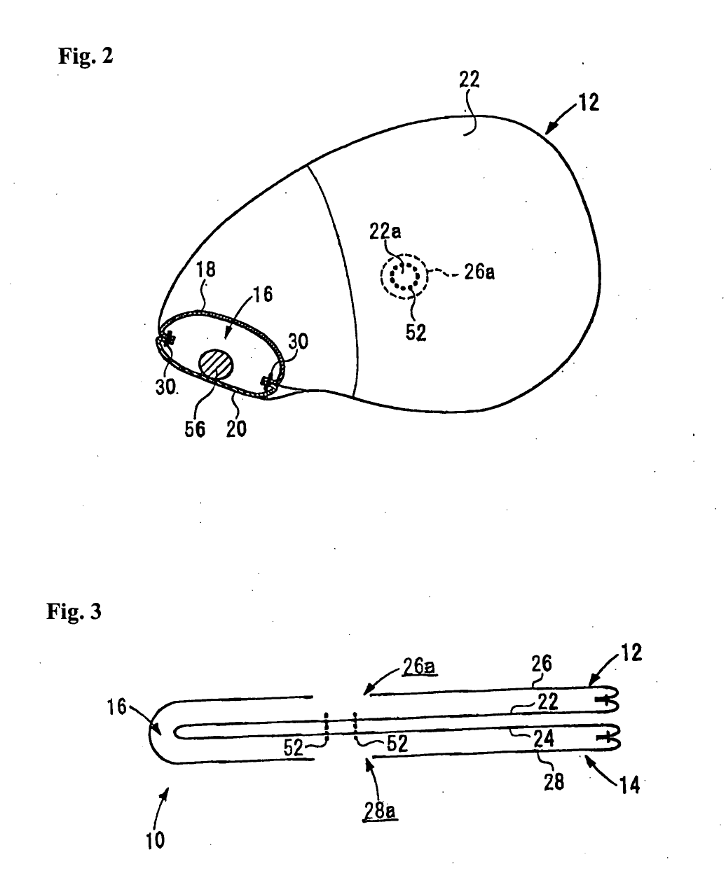

An airbag 10 according to a first embodiment of the present invention will be described with respect to FIGS. 1A, 1B, 2, and 3. The airbag 10 includes a right airbag section 12 that inflates in the right front of an occupant, a left airbag section 14 that inflates in the left front of the occupant, and a communicating part 16 that enables the proximal (base) ends of the right and left airbag sections 12, 14 to communicate fluidically. Midpoints (in the direction of inflation) of the right and left airbag sections 12, 14 are joined together with a seam 52. The midpoints may be approximated for manufacturing ease. The communicating part 16 defines part of a base end of the airbag 10; the right and left airbag sections 12, 14 inflate in the direction away from the communicating part 16.

In this embodiment, with the airbag 10 in an inflated state, a space 13 is produced between the distal ends of the right and left airbag sections 12, 14. The space 13 is directed (upward in FIG. 1B) toward the breastbone of an occupant. With the airbag 10 in a fully inflated state, the space between the distal end 12t of the right airbag section 12 and the distal end 14t of the left airbag section 14 may be, e.g., from about 150 to about 350 mm wide. Moreover, in some embodiments the space 13 may be about 170 to about 330 mm wide.

The airbag 10 is constructed of panels 18, 20, 22, 24, 26, and 28, which are stitched together. The rear inner panel 18 defines a center-side surface, which joins the right and left airbag sections 12, 14. Specifically, the rear panel 18 joins a proximal end of a front inner panel 22 of the right airbag section 12 to a front inner panel 24 of the left airbag section 14, thereby creating a surface that defines a distal side of the communicating part 16; the rear outer panel 20 correspondingly defines a proximal side of the communicating part 16. The right and left front inner panels 22 and 24 define facing surfaces of the right and left airbag sections 12, 14. Right and left front outer panels 26, 28, which define outer surfaces of the airbag 10, are provided opposite to the right and left front inner panels 22, 24.

Reference numeral 30 denotes a seam (e.g., a sewing thread) that stitches the rear inner panel 18 and the rear outer panel 20 together. Reference numerals 32 and 34 denote seams that sew the rear inner panel 18 and the right and left front inner panels 22, 24 together, respectively. Reference numerals 36 and 38 denote seams that sew the rear outer panel 20 and the right and left front outer panels 26, 28 together, respectively.

The right and left front outer panels 26, 28 have vent holes 26a and 28a, respectively. The vent holes 26a, 28a are disposed in positions at which they align with each other when the right and left airbag sections 12, 14 are flattened such that the right and left inner and outer panel 26, 22, 24, and 28 are stacked, as best shown in FIG. 3.

As previously mentioned, midpoints of the right and left front inner panels 22, 24 are joined by a seam 52 such that right and left parts 22a, 24a of the inner panels 22, 24 are aligned with the vent holes 26a, 28a in the right and left outer panels 26, 28, when the airbag 10 is uninflated. As a result, the seam 52 in the right and left parts 22a, 24a may be made (e.g., by a sewing machine) through the vent holes 26a, 28a in the right and left outer panels 26, 28. Accordingly, the right and left airbag sections 12, 14 may joined together such that the right and left inner panels 22, 24 are overlaid and stitched together, without requiring a belt, tongue, or the like for the joining. Thus, the volume of the joined portion of the right and left airbag sections 12, 14 is small. Moreover, as the stitching of the inner panels 22, 24 can be made through the vent holes 26a and 28a in the outer panels 26, 28 via a sewing machine, the stitching is easy and, therefore, does not meaningfully change the fabrication time for the twin airbag 10.

The distance from the proximal end 10e of the inflated airbag to the seam 52 may be, e.g., from about 30% to about 70% of the overall length of the inflated airbag 10. Moreover, in some embodiments the distances between the proximal end 10e of the airbag 10 and the seam 52 may be from about 40% to about 55% of the overall length of the airbag 10.

The rear outer panel 20 that constructs the outer surface of the communicating part 16 has a pair of slits 54 that are configured to receive an inflator. As shown in FIGS. 1A and 1B, a rod-like inflator 56 may be used. The rod-like inflator 56 may be inserted into the slits 54 such that it passes through the communicating part 16 in the width direction of the vehicle. Both ends of the inflator 56 may be disposed outside the airbag 10.

The airbag 10 is mounted to an airbag system for protecting an occupant in a collision. The airbag system has a box-shaped casing in, and to, which the airbag 10 is fastened. Reference numerals 58 in FIG. 1B indicate insertion holes for fastening means (not shown), such as bolts, to join the airbag 10 with the casing. Both ends of the inflator 56 may also be fixed to the casing. The airbag system is constructed in such a way that the airbag 10 is accommodated in the casing in a folded state and a cover (not shown), such as a lid, is mounted on the casing so as to cover the folded airbag 10; the cover is cleaved by the pressure from the airbag 10 upon inflation.

The airbag system is mounted to, for example, an instrument panel in front of a passenger seat of a car. In a car crash, the inflator 56 emits a jet of gas into the communicating part 16. The gas from the inflator 56 flows through the communicating part 16 into the right and left airbag sections 12, 14, thereby inflating the right and left airbag sections 12, 14 in the right and left front of the occupant, respectively.

In the airbag 10, as the right and left airbag sections 12, 14 are joined at midpoints thereof by a seam 52, when one of the sections 12 inflates first and the inflation of the other section 14 is delayed, the first inflating airbag section 12 draws the later inflating airbag section 14, thereby accelerating the inflation of the later inflating section 14. Thus, both the right airbag section 12 and the left airbag section 14 not only inflate smoothly, they also inflate substantially simultaneously (and symmetrically) from the initial stage of inflation.

When the airbag 10 is in a fully inflated state, the breastbone space 13 is produced between the distal ends of the right airbag section 12 and the left airbag section 14. As a result, the inflated right airbag section 12 receives the right chest portion of the occupant, the inflated left airbag section 14 receives the left chest portion of the occupants, and the space 13 receives the occupant's breastbone. Accordingly, the reaction force applied to the vicinity of the breastbone, when the airbag receives the occupant, is low.

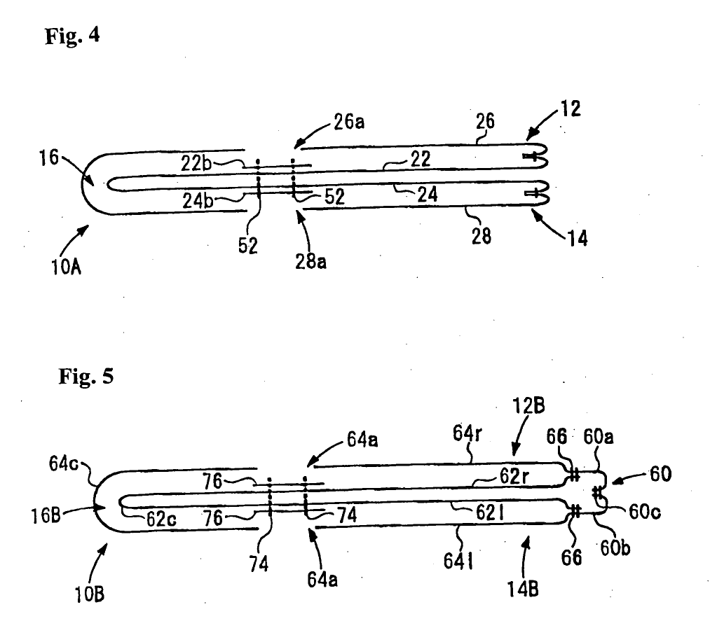

The invention may have a reinforcing patch on the inner panels 22, 24 of the right and left airbag sections 12, 14. FIG. 4, which is a cross-sectional view of an airbag 10A with such a structure, shows how the inner panels 22, 24 of the right and left airbag sections 12, 14 are stitched together. FIG. 4 also shows the panel structure of the airbag 10A in a simplified manner, i.e., in a manner similar to that of the embodiment shown in FIG. 3.

In the airbag 10A, the right and left parts 22a, 24a of the right and left front inner panels 22, 24 that are to be stitched not only align with the vent holes 26a and 28a of the front outer panels 26 and 28 (when the right and left airbag sections 12, 14 are flattened such that the panels 26, 22, 24 and 28 are stacked), the right and left parts 22a, 24a also have patches 22b, 24b. The patches 22b, 24b may be temporarily bonded to the parts 22a, 24a by sewing or bonding or the like. The panels 22 and 24 are stitched together such that the right and left parts 22a, 24a are stacked and sewn (e.g., using a sewing machine), together with the patches 22b, 24b, through the vent holes 26a and 28a. The patches 22b, 24b serve to increase the stitching strength of the seam 52. The other structures of the airbag 10A are the same as that of the airbag 10 in FIGS. 1A, 1B, 2, and 3.

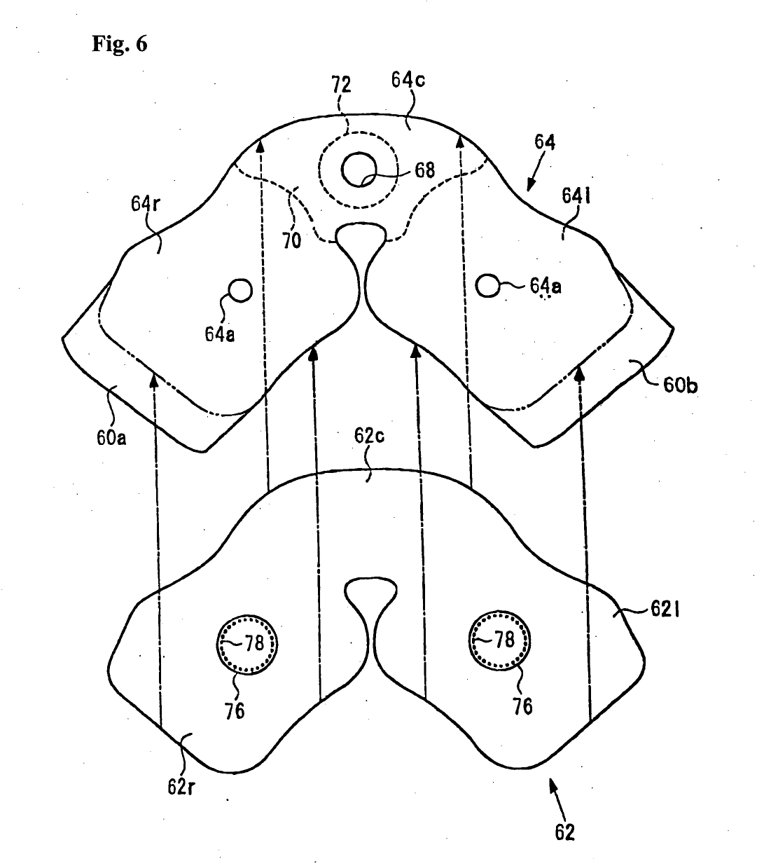

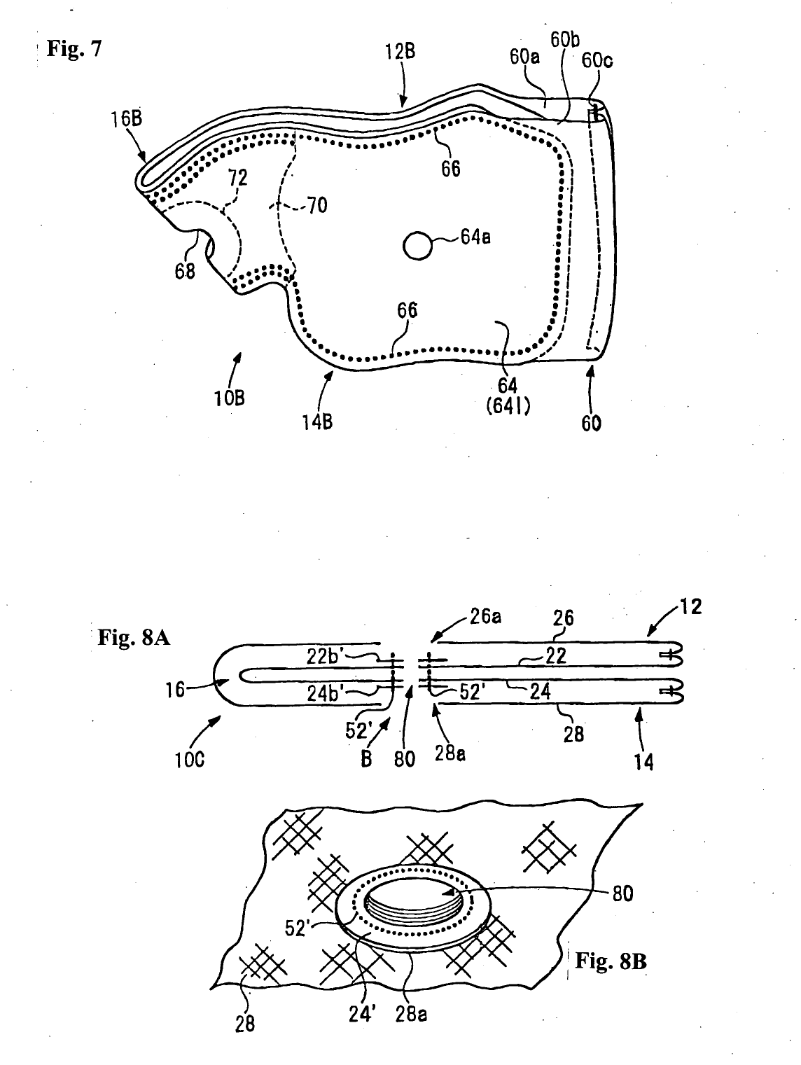

FIGS. 5-7 address a third embodiment of the present invention. FIG. 5, which is a cross-sectional view of an airbag 10B, shows how inner and outer panels 62, 64 of right and left airbag sections 12B, 14B are stitched together. The right and left airbag sections 12B, 14B respectively inflate in the right front and the left front of an occupant. A communicating part 16B enables the proximal (i.e., base) ends of the right and left airbag sections 12B, 14B to communicate fluidically. A tie panel 60 connects the distal ends of the right and left airbag sections 12B, 14B in the direction of inflation.

In this embodiment, the airbag 10B is constructed such that: (a) an inner panel 62 (which is constructed of three panel portions 62r, 62l, 62c) defines a contiguous surface of the right airbag section 12B, the left airbag section 14B, and the communicating part 16B; and (b) an outer panel 64 (which is also constructed of three panel portions 64r, 64l, 64c) defines a contiguous surface of the right airbag section 12B, the left airbag section 14B, and the communicating part 16B. The inner and outer panels 62, 64 are stitched together by a seam 66.

The inner panel 62 includes a right inner panel section 62r that defines the inner side surface of the right airbag section 12B, a left inner panel section 62l that defines the inner side surface of the left airbag section 14B, and an inner communicating panel section 62c that connects the right and left inner panel sections 62r, 62l. The outer panel 64 includes a right outer panel section 64r that defines the outer side surface of the right airbag section 12B, a left outer panel section 64l that defines the outer side surface of the left airbag section 14B, and an outer communicating panel section 64c that connects the right and left outer panel sections 64r, 64l. The outer communicating panel section 64c has an inflator opening 68 in which a fireproofing cloth 70 is provided; a reinforcing cloth 72 is provided around the inflator opening 68.

The right and left outer panel sections 64r, 64l each have a vent hole 64a. The vent holes 64a are disposed in positions in which they are aligned when the right and left airbag sections 12B, 14B are flattened (i.e., when the panels 64r, 62r, 62l, and 64l are stacked). Midpoints (in the inflation direction) of the right and left airbag sections 12B, 14B are joined together with a seam 74. The joined portion is formed such that the right and left inner panel sections 62r, 62l are overlaid and sewn (e.g., using a sewing machine) together through the vent holes 64a. In addition, the stitched portion of each of the right and left inner panel sections 62r, 62l has a reinforcing patch 76, which is affixed by a seam 78.

The tie panel 60 is composed of two panel sections 60a, 60b that extend from the distal ends of the right and left airbag sections 12B, 14B, respectively. In this embodiment, the tie panel sections 60a, 60b extend from the front rims of the right and left outer panel sections 64r, 64l and are integrated with the right and left outer panel sections 64r, 64l, respectively. The distal ends of the right and left airbag sections 12B, 14B are joined together by stitching the distal ends of the panel sections 60a, 60b with a seam 60c.

The airbag 10B with such a structure offers the same advantages as those of the airbags 10, 10A in FIGS. 1A-4. In addition, however, with the airbag 10B of this embodiment, upon completion of inflation, the distal ends of the right and left airbag sections 12B, 14B face the shoulders of the occupant whereas the tie panel 60, which connects the airbag sections 12B, 14B, faces the chest and head of the occupant. When the chest and head of the occupant strike against the tie panel 60, the tie panel 60 elastically moves backward, thereby receiving the chest and head of the occupant relatively softly.

FIG. 8A, which is a cross-sectional view of an airbag 10C according to a fourth embodiment of the present invention, shows how the right and left airbag sections 12, 14 may be stitched together. FIG. 8B is an enlarged perspective view of part B in FIG. 8A. The airbag 10C of this embodiment has the same panel structure as that of the airbag 10A of FIG. 4, i.e., the portions to be stitched of the right and left inner facing panels 22, 24 have patches 22b′ and 24b′ backed from the interior of the airbag. The portions to be stitched are sewn with a seam 52′ together with the patches 22b′ and 24b′.

In this embodiment, the seam 52′ is shaped like a ring, as shown in FIG. 8B. On the inside of the seam 52′, an opening 80 is provided; the shape of the opening 80 is not particularly limited. The opening 80 passes through the patches 22b′ and 24b′ and the right and left inner panels 22, 24. Accordingly, in the airbag 10C, the right and left airbag sections 12, 14 may communicate with each other through the opening 80. Accordingly, upon inflation of the airbag 10C, the inner pressures of the right and left airbag sections 12, 14 may remain substantially equal. The other structures of the airbag 10C are the same as that of the airbag 10A in FIG. 4.

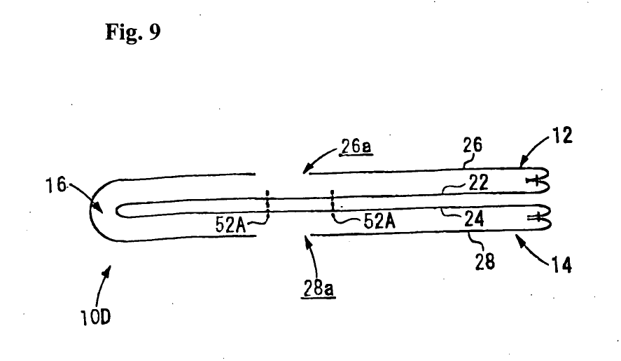

According to the previously described embodiments, of the inner facing panels of the right and left airbag sections, only the portions exposed in the vent holes (when the right and left airbag sections are flattened) are stitched together. Alternatively, the portions protruding from the vent holes (i.e., the portions not exposed inside the vent holes) may be stitched. FIG. 9, which is a cross-sectional view of an airbag 10D with such a structure, shows how the right and left airbag sections 12, 14 may be stitched together.

The airbag 10D has the same panel structure as that of the airbag 10 in FIGS. 1A-3. In the airbag 10D of this embodiment, however, of the right and left inner facing panels 22 and 24, the portions exposed inside the vent holes 26a and 28a (through the portions protruding from the vent holes 26a and 28a with the right and left airbag sections 12, 14 flattened) are stitched together with a seam 52A, which is shaped like a ring and which has a diameter that is larger than that of the vent holes 26a and 28a.

The right and left inner panels 22, 24 are stitched as follows. First, the right and left airbag sections 12, 14 are flattened. Then, the portions of the right and left inner panels 22, 24 that are exposed inside the vent holes 26a and 28a are stitched together on a sewing machine through the vent holes 26a and 28a. Then, either the stitched portion is removed from the inside of the vent holes 26a and 28a or the peripheries of the vent holes 26a and 28a are torn. In either case, the portions protruding from the vent holes 26a, 28a are exposed; these protruding portions are then stitched on a sewing machine through the vent holes 26a and 28a. The way of stitching the protruding portions is, however, not limited in any particular manner. Stitching the right and left inner facing surfaces 22, 24 of the right and left airbag sections 12, 14 across such a wide area reduces the stress applied to the stitched portions when the airbag 10D inflates and/or when the inflated airbag 10D receives an occupant. As a result, the durability of the airbag 10D is advantageously increased. Moreover, the larger the stitched region, the greater the advantage.

While the embodiments in FIGS. 1A-3 are shown as using a rod-like inflator, the invention may use other types of inflators, e.g., a disc-shaped (i.e., “disc type”) inflator, which is thicker and shorter than the rod-like inflator. The circular inflator opening 68 provided at the rear end of the airbag 10B in FIGS. 5-7 is an opening for such a disc-type inflator.

The priority application, Japanese Application No. 2004-364751, which was filed on Dec. 16, 2004, is incorporated herein by reference in its entirety.

Given the disclosure of the present invention, one versed in the art would appreciate that there may be other embodiments and modifications within the scope and spirit of the invention. Accordingly, all modifications attainable by one versed in the art from the present disclosure that are within the scope and spirit of the present invention are to be included as further embodiments of the present invention. The scope of the present invention is to be defined as set forth in the following claims.

What is claimed is:

1. An airbag that is configured to inflate in a direction in which a distal end of the airbag moves away from a base end of the airbag, the airbag comprising:
a left airbag section that is configured to inflate toward the left front of an occupant; and
a right airbag section that is configured to inflate toward the right front of the occupant,
wherein the left and right airbag sections are connected at the base end of the airbag along inner sides of the airbag sections,
wherein the left and right airbag sections are configured to be inflated by a common inflator,
wherein each of the left and right airbag sections is provided with at least one vent hole on an outer side, which is opposite to the inner side of the respective airbag section,
wherein, when the left and right airbag sections are uninflated and are flattened such that the inner sides are adjacent the associated outer sides:
(a) the vent holes align with each other, and
(b) the inner sides of each of the left and right airbag sections opposite the associated vent holes are stitched together such that midpoints of the inner sides of the left and right airbag sections are joined.

2. The airbag according to claim 1, wherein the joined portions of the inner sides of the left and right airbag sections each have a patch.

3. The airbag according to claim 1,
wherein the joined portions of the inner sides of the left and right airbag sections are stitched together with a ring-shaped seam; and
wherein an opening is provided inside the ring-shaped seam, through which the left and right airbag sections communicate.

4. An airbag system comprising:
an inflator; and
an airbag that is configured to inflate in a direction in which a distal end of the airbag moves away from a base end of the airbag, the airbag comprising:
a left airbag section that is configured to inflate toward the left front of an occupant; and
a right airbag section that is configured to inflate toward the right front of the occupant,
wherein the left and right airbag sections are connected at the base end of the airbag along inner sides of the airbag sections,
wherein the left and right airbag sections are configured to be inflated by the inflator,
wherein each of the left and right airbag sections is provided with at least one vent hole on an outer side, which is opposite to the inner side of the respective airbag section,
wherein, when the left and right airbag sections are uninflated and are flattened such that the inner sides are adjacent the associated outer sides:
(a) the vent holes align with each other, and
(b) the inner sides of each of the left and right airbag sections opposite the associated vent holes are stitched together such that midpoints of the inner sides of the left and right airbag sections are joined.

5. The airbag system according to claim 4, wherein the joined portions of the inner sides of the left and right airbag sections each have a patch.

6. The airbag system according to claim 4,
wherein the joined portions of the inner sides of the left and right airbag sections are stitched together with a ring-shaped seam; and
wherein an opening is provided inside the ring-shaped seam, through which the left and right airbag sections communicate.

7. An airbag for protecting an occupant of a vehicle comprising:
left and right airbag sections separated by a gap and integrally connected at a base of the airbag adjacent an inflator opening so that both the left and right sections receive inflation gas through the opening,
wherein each of the left and right airbag sections includes a vent opening located on an outer side of each section facing away from the other section;
wherein, when the left and right airbag sections are uninflated and inner sides of the left and right airbag sections are adjacent the associated outer sides:
(a) the vent holes align with each other, and
(b) the inner sides of each of the left and right airbag sections opposite the associated vent holes are stitched together, and
wherein inner sides of each of the left and right airbag sections are connected together.

8. The airbag of claim 7, wherein the inner sides are connected by stitching located opposite the vent openings.

9. The airbag of claim 8, further comprising additional stitching located away from the vent opening for connecting the inner sides together.

10. The airbag of claim 7, further comprising additional openings in the inner sides to allow inflation gas to pass between the left and right sections through the additional openings.

11. The airbag of claim 10, wherein the additional openings are surrounded by stitching for connecting the left and right sections together.
